(19) United States
(12) Patent Application Publication
(10) Pub. No.: US 2024/0417513 A1
(43) Pub. Date: Dec. 19, 2024

(54) CONTINUOUS TRANSESTERIFICATION OF POLYALKYLENE TEREPHTHALATE

(71) Applicant: ACTEGA Rhenania GmbH, Grevenbroich (DE)

(72) Inventors: Karolin Wendrich, Grevenbroich (DE); Lukas Gwiasda, Bochum (DE); Anna Haeger, Munich (DE); Björn Askevold, Düsseldorf (DE)

(21) Appl. No.: 18/703,619

(22) PCT Filed: Oct. 25, 2022
(86) PCT No.: PCT/EP2022/079770

§ 371 Date: Apr. 22, 2024

(30) Foreign Application Priority Data
Nov. 3, 2021 (EP) 21206233.5

(51) Int. Cl. C08G 63/91; B65D 65/40; C09J 167/02

(52) U.S. Cl. CPC C08G 63/916; B65D 65/40; C09J 167/02

(57) ABSTRACT

The invention relates to the use of a composition (PR) having 4.0-10.4 mol/kg carboxylic acid ester functional groups and 0.1-20.8 mol/kg hydroxyl groups comprising: i) polyalkylene terephthalate (PE), ii) diol (DO) having an atmospheric pressure boiling point below 235° C. and iii) transesterification catalyst (TC), wherein 20-100 mol % of the contained carboxylic acid ester functional groups are provided by the polyalkylene terephthalate (PE) and 5-100 mol % of the contained hydroxyl groups are provided by the diol (DO) having a boiling point below 235° C.: as a pre-product in a continuous transesterification process which is performed in an extruder.

The present invention relates to a continuous transesterification process and to the use of a composition.

Terephthalate polyester resins like polyalkylene terephthalate (PE) are thermoplastic polymers which are widely used in the plastics industry. PE is used in the manufacturing of film, bottles and plastic containers of all kinds. It is also used in the manufacturing of fabrics and textile materials.

Terephthalate polyester resins might be produced via polycondenstation of the corresponding monomers or via transesterification of polyesters, usually in batch reactors as described e.g. in U.S. Pat. No. 4,849,465. However, the (transesterification) production in batch reactors is time consuming and it is also difficult to handle the corresponding process which is also caused by the high viscosity of the used PE transesterification educts.

An improvement concerning handling and efficiency is normally the use of continuous reactors (for the transesterification).

A special production (by transesterification) in such a continuous reactor is described in WO2019229237. It is proposed to perform the transesterification reaction in an extruder. The relevant process also works in the absence of solvent. However, the products which are received by the described extruder production process are generally not appropriate for many applications (like food packaging). Furthermore, according to the said extruder process it only works satisfactorily if as polyester educts exclusively polyalkylene terephthalate types are used. Thus, the flexibility of this process is also limited because the corresponding utilization of other polyester type educts does not work sufficiently.

However, such a flexibility concerning the selection of the educts facilitates the production of product mixtures with desired properties (like glass transition temperature/crystallinity and polarity).

It is an object to the present invention to provide an economical process for the transesterification of polyalkylene terephthalate (PE). The received transesterification product should be of high quality and should be also appropriate concerning the food packing application.

The solution to this problem is a continuous transesterification process which is performed in an extruder comprising the steps of:
step 1): the components of a pre-product are introduced into the extruder, which are at least present as
   i) polyalkylene terephthalate (PE),
   ii) diol (DO) having an atmospheric pressure boiling point below 235° C. and
   iii) transesterification catalyst (TC),
   with the proviso that the overall composition of the pre-product which refers to its components added per unit of time fulfills the following requirements:
      4.0-10.4 mol/kg carboxylic acid ester functional groups and 4.0-20.8 mol/kg hydroxyl groups are provided per unit of time,
      20-100 mol % of the provided carboxylic acid ester functional groups are contributed by the polyalkylene terephthalate (PE),
      5-100 mol % of the provided hydroxyl groups are contributed by the diol (DO) having a boiling point below 235° C.;
step 2): reacting the introduced components in a reacting zone of the extruder to generate a transesterification mixture and
step 3): discharging the transesterification mixture generated in step 2).

The invention also relates to the use of a composition (PR) having 4.0-10.4 mol/kg carboxylic acid ester functional groups and 4.0-20.8 mol/kg hydroxyl groups comprising:
i) polyalkylene terephthalate (PE),
ii) diol (DO) having an atmospheric pressure boiling point below 235° C. and
iii) transesterification catalyst (TC), wherein
20-100 mol % of the contained carboxylic acid ester functional groups are provided by the polyalkylene terephthalate (PE) and 5-100 mol % of the contained hydroxyl groups are provided by the diol (DO) having a boiling point below 235° C.;
as a pre-product in a continuous transesterification process which is performed in an extruder.

The process (and the use) according to the invention enables short residence times, so that even relatively small amounts of product can be produced in an economical manner. According to the present invention also high-viscosity polyesters might be reacted with the (relatively) low-boiling polyols. The process according to the present invention has a low energy requirement because the reaction can also be carried out at lower temperatures than in a conventional continuous reactor (because extruder reactors require only a slight softening of the viscous polyester educts, which means that lower temperatures are needed).

As already mentioned above, the reaction in the extruder makes it possible to process or react the highly viscous polyesters even at relatively low temperatures, which means that the end product is spared (high temperatures usually lead to decomposition reactions, which deteriorates the product quality). According to the invention, waste PE can also be used as starting materials, whereby not only recycling but even upcycling can be achieved.

The received transesterification products are generally of high quality and might be used for direct and indirect food contact applications.

It is not necessary to pre-mix educts and catalyst before introducing into the extruder. It is also possible to feed said components at different spatial locations into the extruder so that the components might be mixed for the first time within the extruder.

Furthermore, the process according to the present invention is flexible concerning the educts to be used: It is not only possible to use polyalkylene terephthalate as polyester but e.g. additionally also other dicarbon acid based polyester types.

According to a special embodiment in this connection methyl esters are additionally used. Methyl esters show a high reactivity, wherein methanol is generated during the reaction which is easy (and also completely) removeable by evaporation. According to this embodiment, less than 100 mol % of the carboxylic acid ester functional groups were contributed by the polyalkylene terephthalate (PE) and wherein carboxylic ester functional groups were additionally contributed by the use of methyl esters. In this case, typically 5-80 mol %, preferably 5-50 mol % of the provided carboxylic acid ester functional groups are contributed by methyl esters. An appropriate methyl ester is e.g. dimethyl isophthalate.

The Process in Case Said Educts were not Pre-Mixed Before Fed into the Extruder (Individual Feed of Relevant Educts):

According to a preferred embodiment 4.5-9.5 mol/kg carboxylic acid ester functional groups and 3.0-15.0 mol/kg hydroxyl groups are provided per unit of time and 50-100 mol % of the provided carboxylic acid ester functional groups are contributed by the polyalkylene terephthalate (PE) and 20-100 mol % of the provided hydroxyl groups are contributed by the diol (DO) having a boiling point below 235° C.

In a preferred embodiment to the invention the relevant educts (and preferably also the catalyst) were introduced into the extruder (reactor) through a feeding zone (preferably in a pre-mixed way).

The Process in Case the Relevant Educts were Pre-Mixed Before Fed into the Extruder-Use of the Pre-Mixed Composition (PR):

According to a special embodiment in a step before step 1) the components of the pre-product are pre-mixed so that in step 1) a composition (PR) is introduced into the extruder having 4.0-10.4 mol/kg carboxylic acid ester functional groups and 0.1-20.8 mol/kg hydroxyl groups comprising:
i) polyalkylene terephthalate (PE),
ii) diol (DO) having an atmospheric pressure boiling point below 235° C. and
iii) transesterification catalyst (TC), wherein
20-100 mol % of the contained carboxylic acid ester functional groups are provided by the polyalkylene terephthalate (PE) and 5-100 mol % of the contained hydroxyl groups are provided by the diol (DO) having a boiling point below 235° C.

### Referring to the Preferred (Pre-Mixed) Composition (PR):

Typically, the composition (PR) has 4.5-9.5 mol/kg carboxylic acid ester functional groups and 3.0-15.0 mol/kg hydroxyl groups and 50-100 mol % of the contained carboxylic acid ester functional groups are provided by the polyalkylene terephthalate (PE) and 20-100 mol % of the contained hydroxyl groups are provided by the diol (DO) having a boiling point below 235° C.

### Referring to the Continuous Transesterification Process According to the Present Invention and to the Use According to the Present Invention:

Normally, the intrinsic viscosity of the polyalkylene terephthalate (PE) is 0.40-0.98, preferably 0.70-0.85 (DIN EN ISO 1628-5).

The PE might be used as melt (which is preferred) or in a solution (dissolved in solvents). Typically, the amount of solvent in such a melt is lower than 20 wt. % but preferably no solvent is used (in the melt).

Furthermore, additives (e.g. rheology additives) might be used in order to perform the process according to the present invention.

Often at least 20 wt. %, preferably at least 40 wt. % of the species of the polyalkylene terephthalate (PE) are provided by polyethylene terephthalate (PET).

Preferably, at least 5 wt. %, preferably at least 10 wt. % of the species of the diol (DO) have an atmospheric pressure boiling point below 215° C.

The usage of low boiling polyols (especially below said 215° C.) is normally advantageous for the properties of the synthesized polyester.

Typically, at least 5 wt. %, preferably at least 10 wt. % of the species of the diol (DO) are provided by 2,2-diemethyl propane-1,3-diol (NPG).

The use of such low boiling diols generally has an influence concerning the quality of the polymeric end product: it is possible to adjust solubility, compatibility, physical hardness and flexibility. Normally, e.g. crystallinity and flexibility can be fine-tuned if low boiling diols are used instead of—or in addition to—corresponding higher boiling diols.

Preferably, species of the transesterification catalyst (TC) are provided by a lewis-acid.

Generally said lewis acid might be selected from titanium compounds, zinc compounds, antimony compounds, zirconium compounds, germanium compounds, ionic liquids and lead compounds. In a most preferred embodiment of the invention, the transesterification catalyst is selected from zinc acetate and tetra-n-butyl titanate (TNBT).

According to a preferred embodiment, the transesterification is performed at temperatures of 240-310° C., preferably at 260-290° C.

Typically, the extruder is a twin screw extruder.

Especially, in appropriate extruder types a high surface area and an enhanced heat transfer allow a fast reaction.

Normally, the residence time of the PE in the extruder is 1-20 minutes, preferably 2-8 minutes. The residence time is determined optically (by human eye): At all spatial locations where PE is fed into the extruder, 1 g of PE is fed in (each once and at the same time), which contains 1 percent by weight of (pre-mixed in the PE) carbon black powder. It is determined when the black color becomes visible (lower limit) and when the black color is no longer visible (upper limit)—where the product outlet(s) of the extruder is monitored optically. The time difference between the upper limit and the lower limit corresponds to the residence time.

In many cases during the transesterification process in the extruder volatile components are generated which are preferably vacuum-removed (e.g. methanol if methyl esters were used). In this case the used extruder reactor normally works under reduced pressure.

Preferably, the transesterification process is performed in the absence of any solvent being not a transesterification-reactive component.

Typically, the transesterification mixture discharged in step 3) is used in a further step as a binder for coatings or as a lamination adhesive, preferably for the manufacturing of food packaging.

The present invention is further described below by using examples.

### TRIALS

The experiments were performed using a Brabender Co-Rotating Clamshell Twin Screw Extruder Model with 3 independent heating zones. The screw design consists of forward and reverse conveying elements, forward and reverse kneading blocks, and teeth elements. Polyethylene terephthalate (PET) (Indorama), dimethyl isophthalate (DMI), 2,2-Dimethylpropane-1,3-diol (NPG), [4-(hydroxymethyl) cyclohexyl]methanol (CHDM) and the catalyst tetra-n-butyl titanate (TNBT) (VWR) were premixed and fed through a single spiral screw feeder. When the amount of the catalyst is given in weight %, such amount is calculated based on the total weight of the components. All materials were dosed through a 1 L stainless steel hopper.

### Performance in Said Twin Screw Extruder

### Composition

The following materials are used in the experiments 1-3

TABLE 1
Educt composition of example 1-3

| | quantity |
|---|---|
| | (amount) |
| Compound | [wt. %] |
| “Ramapet N180” (PET): Intrinsic viscosity dl/g | 34 |
| 0.80 ± 0.02; Bulk Density Poured 830 kg/m3; | |
| Glass transition point Tg (dry) 78 ± 2 | |
| Dimethyl isophthalate (DMI) | 34 |
| [4-(hydroxymethyl)cyclohexyl]methanol | 10 |
| (CHDM) (atmosheric boiling point higher than | |
| 260° C.) | |
| 2,2-Dimethylpropane-1,3-diol (NPG) | 22 |
| (atmospheric boiling point 208° C.) | |

### Properties of the Educt Mixture:

6.1 mol/kg carboxylic acid ester functional groups and 9.57 mol/kg hydroxyl groups;
50 mol % of the contained carboxylic acid ester functional groups are provided by the polyalkylene terephthalate (PET)
75 mol % of the contained hydroxyl groups are provided by NPG

The mixture is feed via the single screw feeder with a dosing rate of 0.1 kg/h.

The residence time of the PE in the extruder is 3.2 minutes, where the temperature profile in the extruder is shown in table 2.

The resulting polyol modified PET exited the extruder as a melt and was collected into cans and cooled at ambient conditions.

a. Test Series

TABLE 2
test series on benchtop extruder.

| Example | unit | 1 | 2 | 3 |
|---|---|---|---|---|
| Catalyst amount | wt. % | 0.4 | 0.4 | 0.4 |
| Temp. heat zone 1 | ° C. | 280 | 280 | 280 |
| Temp. heat zone 2 | ° C. | 290 | 300 | 315 |
| Temp. heat zone 3 | ° C. | 290 | 300 | 315 |
| Rotation speed rpm | min⁻¹ | 50 | 50 | 50 |
| Solubility in THF | | good | very good | very good |

Due to the use of the lower boiling diol (NPG) the received product has a relative low crystallinity and a sufficient flexibility which gives this product the properties required for use as a lamination adhesive.

### Analytical Results

The clear products of example 1-3 are soluble in THF. The obtained resins were characterized by GPC and the acid no. was determined. ¹H, ¹³C, COSY, and ¹H-¹³C HMQC NMR was measured in CDCl₃.

TABLE 3
analytical results.

| | M_{w} | Mₙ | |
|---|---|---|---|
| Sample | [g/mol] | [g/mol] | PDI |
| Sample 1 | 2846 | 1503 | 1.9 |
| Sample 2 | 3326 | 1690 | 2.0 |
| Sample 3 | 4750 | 2268 | 2.1 |

Examples 1-3 demonstrate that the temperature can be used to control the molecular weight of the resulting modified polyester resin. Higher temperatures gave material with higher molecular weight. ¹H, ¹³C, COSY, and ¹H-¹³C HMQC NMR results of the material show the presence of mono and diester of EG, NPG and CHDM. Only traces of free dimethyl isophthalate could be detected.

Examples 1-3 demonstrate that dimethyl ester of carbon acids can be used to produce modified polyesters containing not only terephthalic acid.

### Measurements

GPC measurement were performed using Agilent Infinity 1260 GPC. The Infinity GPC is equipped with Degasser, isocratic pump, autosampler, refractive index detector and 2 lined up mixed D columns thermostated at 40° C. The solvent used is stabilized tetrahydrofuran (THF)≥99.7% with a flow rate of 1 mL/min. Analysis were performed with Agilent Chemstation software. Reference samples of polystyrene purchased from Agilent are used to develop a calibration curve. The standards range in molecular weight of 500 to 30,000 Daltons. The calibration curve was second order fitted with a r-value of 0.998.

Samples to be analyzed are first dissolved in THF (30 mg/mL). The sample is then filtered through a 2 ml syringe with a 0.45 micron filter housing. A volume of 0.1 microliters is injected.

¹H, ¹³C COSY, ¹H-¹³C HMQC NMR spectra were measured in CDCl₃ using 500 MHz NMR Bruker with gryo head.

### List of Abreviations

CHDM Cyclohexanedimethanol
DMI Dimethyl isophthalate
EG Ethylene glycol
GPC gel permeation chromatography
Mₙ number average molecular weight
M_{w} weight average molecular weight
NPG Neopentylglycol
PET polyethylentherephtalate
PDI Polydispersity index
RPM revolutions per minute
TEG Triethylene glycol
THF tetrahydrofuran
TNBT tetra-n-butyl titanate

1. (canceled)

2. A continuous transesterification process which is performed in an extruder comprising the steps of:
step 1): introducing the components of a pre-product into the extruder, the components comprising
i) polyalkylene terephthalate (PE),
ii) diol (DO) having an atmospheric pressure boiling point below 235° C. and
iii) transesterification catalyst (TC),
with the proviso that the overall composition of the pre-product which refers to its components added per unit of time fulfills the following requirements:
4.0-10.4 mol/kg carboxylic acid ester functional groups and 4.0-20.8 mol/kg hydroxyl groups are provided per unit of time,
20-100 mol % of the provided carboxylic acid ester functional groups are contributed by the polyalkylene terephthalate (PE),
5-100 mol % of the provided hydroxyl groups are contributed by the diol (DO) having an atmospheric pressure boiling point below 235° C.;
step 2): reacting the introduced components in a reacting zone of the extruder to generate a transesterification mixture and
step 3): discharging the transesterification mixture generated in step 2).

3. The continuous transesterification process according to claim 2, wherein 4.5-9.5 mol/kg carboxylic acid ester functional groups and 3.0-15.0 mol/kg hydroxyl groups are provided per unit of time and 50-100 mol % of the provided carboxylic acid ester functional groups are contributed by the polyalkylene terephthalate (PE) and 20-100 mol % of the provided hydroxyl groups are contributed by the diol (DO) having an atmospheric boiling point below 235° C.

4. The continuous transesterification process according to claim 2, in which in a step before step 1) the components of the pre-product are pre-mixed so that in step 1) a composition (PR) is introduced into the extruder having 4.0-10.4 mol/kg carboxylic acid ester functional groups and 4.0-20.8 mol/kg hydroxyl groups comprising:
i) polyalkylene terephthalate (PE),
ii) diol (DO) having an atmospheric pressure boiling point below 235° C. and
iii) transesterification catalyst (TC), wherein
20-100 mol % of the contained carboxylic acid ester functional groups are provided by the polyalkylene terephthalate (PE) and 5-100 mol % of the contained hydroxyl groups are provided by the diol (DO) having an atmospheric boiling point below 235° C.

5. The continuous transesterification process according to claim 4, where the composition (PR) has 4.5-9.5 mol/kg carboxylic acid ester functional groups and 3.0-15.0 mol/kg hydroxyl groups and 50-100 mol % of the contained carboxylic acid ester functional groups are provided by the polyalkylene terephthalate (PE) and 20-100 mol % of the contained hydroxyl groups are provided by the diol (DO) having an atmospheric boiling point below 235° C.

6. The continuous transesterification process according to claim 2, where the intrinsic viscosity of the polyalkylene terephthalate (PE) is 0.40-0.98 as measured via DIN EN ISO 1628-5.

7. The continuous transesterification process according to claim 2, wherein at least 20 wt. %, of the species of the polyalkylene terephthalate (PE) are provided by polyethylene terephthalate (PET).

8. The continuous transesterification process according to claim 2, wherein at least 5 wt. % of the species of the diol (DO) have an atmospheric pressure boiling point below 215° C.

9. The continuous transesterification process according to claim 2, wherein at least 5 wt. % of the species of the diol (DO) are provided by 2,2-dimethyl propane-1,3-diol (NPG).

10. The continuous transesterification process according to claim 2, wherein the transesterification catalyst (TC) comprises a lewis-acid.

11. The continuous transesterification process according to claim 2, wherein the transesterification is performed at temperatures of 240-310° C.

12. The continuous transesterification process according to claim 2, wherein the extruder is a twin screw extruder.

13. The continuous transesterification process according to claim 2, wherein the residence time of the PE in the extruder is 1-20 minutes.

14. The continuous transesterification process according to claim 2, wherein during the transesterification process in the extruder a vacuum is used to remove volatile components that are generated.

15. The continuous transesterification process according to claim 2, wherein the transesterification process is performed in the absence of any solvent being not a transesterification-reactive component.

16. The continuous transesterification process according to claim 2, wherein less than 100 mol % of the carboxylic acid ester functional groups were contributed by the polyalkylene terephthalate (PE) and wherein carboxylic ester functional groups were additionally contributed by the use of methyl esters.

17. The continuous transesterification process according to claim 16, wherein
5-80 mol % of the provided carboxylic acid ester functional groups are contributed by methyl esters.

18. (canceled)

19. The continuous transesterification process according to claim 2, where the intrinsic viscosity of the polyalkylene terephthalate (PE) is 0.70-0.85.

20. The continuous transesterification process according to claim 7, wherein at least 40 wt. % of the species of the polyalkylene terephthalate (PE) are provided by polyethylene terephthalate (PET).

21. The continuous transesterification process according to claim 8, wherein at least 10 wt. % of the species of the diol (DO) have an atmospheric pressure boiling point below 215° C.

22. The continuous transesterification process according to claim 9, wherein at least 10 wt. % of the species of the diol (DO) are provided by 2,2-dimethyl propane-1,3-diol (NPG).

23. the continuous transesterification process according to claim 10, the transesterification catalyst (TC) comprising tetra-n-butyl titanate (TNBT).

24. The continuous transesterification process according to claim 11, wherein the transesterification is performed at temperatures of 260-290° C.

25. The continuous transesterification process according to claim 13, wherein the residence time of the PE in the extruder is 2-8 minutes.

26. The continuous transesterification process according to claim 17, wherein 5-50 mol % of the provided carboxylic acid ester functional groups are contributed by methyl esters.

27. The product prepared in accordance with the process of claim 2.

28. A laminated food package comprising the product of claim 27 as a lamination adhesive.
